(19) United States
(12) Patent Application Publication
(10) Pub. No.: US 2007/0285931 A1
(43) Pub. Date: Dec. 13, 2007

(54) DIRECT TYPE BACKLIGHT MODULE WITH REINFORCEMENT FRAMES

(75) Inventor: SHAO-HAN CHANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/557,903

(22) Filed: Nov. 8, 2006

(30) Foreign Application Priority Data
Jun. 9, 2006 (CN) 200610061072.2

(51) Int. Cl. F21V 17/12; F21V 11/16

(52) U.S. Cl. 362/374; 362/375; 362/235

(57) ABSTRACT

A backlight module includes a reflective plate, at least one optical plate, a plurality of light sources, two reinforcement frames and a plurality of fixing members. The reflective plate includes a base defining at least one first locking portion, and two opposite sidewalls. The optical plate is disposed on the sidewalls. The light sources are positioned between the optical plate and the base. Each reinforcement frame includes at least one second locking portion corresponding to the first locking portions. The second locking portions of the two reinforcement frames and the first locking portions of the two sidewalls are assembled together by a plurality of fixing members such that the at least one optical plate is fixed on the sidewalls.

### BACKGROUND OF THE INVENTION

1. Field of the Invention

The present invention relates to backlight modules, more particularly, to direct type backlight modules for use in liquid crystal display devices.

2. Discussion of the Related Art

In a liquid crystal display device, liquid crystal is a substance that does not itself illuminate light. Instead, the liquid crystal relies on light received from a light source in order to provide displaying of images and data. In the case of a typical liquid crystal display device, a backlight module powered by electricity supplies the needed light.

Typically, a direct type backlight module includes a plurality of light sources, a plurality of optical sheets, and a frame fixing the light sources and the optical sheets therein. The optical sheets can be selected from the group consisting of a diffusing plate, a prism sheet, and a brightness enhancement film. The optical sheets are used to improve the backlight module's optical uniformity.

Referring to FIG. 7, a typical direct type backlight module 10 is shown. The backlight module 10 includes a reflective plate 11, two optical plates 12, an upper frame 13, a plurality of lamp tubes 14, two lamp-supporting units 15, and two lamp-protecting units 16. The reflective plate 11 has a rectangular shape, and includes a base 111 and two opposite sidewalls 112 extending from two opposite edges of the base 111. The two lamp-supporting units 15 are positioned on the base 111 adjacent two other opposite edges of the base 111, such that each of the lamp-supporting units 15 interconnects corresponding ends of the sidewalls 112. The lamp-supporting units 15 are securely connected with the ends of the sidewalls 112 and the base 111 by a plurality of screws (not shown). Ends of the lamp tubes 14 are respectively fixed to the two lamp-supporting units 15. The two lamp-protecting units 16 cover the two lamp-supporting units 15 respectively. The reflective plate 11, the lamp-supporting units 15, and the lamp-protecting units 16 collectively define a chamber 17 therebetween. The optical plates 12 include a light diffusion plate 121 and a prism sheet 122. A number of screw holes 117 are defined in tops of the sidewalls 112. A number of screw holes 116 are defined in tops of the lamp-protecting units 16. Each of the optical plates 12 includes a plurality of protrusions 123. Each protrusion 123 defines a screw hole 126 corresponding to a respective one of the screw holes 116. The upper frame 13 has a frame body 131 defining a rectangular opening 132 therein. A plurality of screw holes 136 is defined in the frame body 131, corresponding to the screw holes 116 and 117. The optical plates 12 can be fixed onto the sidewalls 112 and the lamp-protecting units 16 by a plurality of screws (not shown) that are inserted through the corresponding screw holes 136 and engaged in the corresponding screw holes 117, and by another plurality of screws (not shown) that are inserted through the corresponding screw holes 136, 126 and engaged in the corresponding screw holes 116.

However, the upper frame 13 is usually formed of metallic material, which makes the backlight module 10 unduly heavy. In addition, the process of fixing the optical plates 12 on the sidewalls 112 and the lamp-protecting units 16 is complicated, because it is difficult to accurately align the screw holes 136, 126, 117 and 116 of the upper frame 13, the optical plates 12, the sidewalls 112 and the lamp-protecting units 16 with each other.

What is needed, therefore, is a direct type backlight module that overcome the above mentioned disadvantages.

### SUMMARY

A direct type backlight module according to a preferred embodiment includes a reflective plate, at least one optical plate, a plurality of light sources, two reinforcement frames and a plurality of fixing members. The reflective plate includes a base and at least two opposite sidewalls extending from the base. A top of each sidewall defines at least one first locking portion. The optical plate is disposed on the sidewalls. The light sources are positioned between the optical plate and the reflective plate. The two reinforcement frames each include at least one second locking portion, the second locking portions corresponding to the first locking portions. The second locking portions of the two reinforcement frames and the first locking portions of the two sidewalls are assembled together by a plurality of fixing members such that the optical plate is fixed on the sidewalls.

Other advantages and novel features will become more apparent from the following detailed description of preferred embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present direct type backlight module. Moreover, in the drawings, like reference numerals designate corresponding parts throughout the several views.

FIG. 1 is an abbreviated, exploded, isometric view of a backlight module according to a first preferred embodiment of the present invention.

FIG. 2 is an enlarged view of a circled portion II of FIG. 1.

FIG. 3 is an enlarged view of a circled portion III of FIG. 1.

FIG. 4 is an enlarged, inverted view of one reinforcement frame of the backlight module of FIG. 1.

FIG. 5 is an abbreviated, isometric view of a reinforcement frame of a backlight module according to a second preferred embodiment of the present invention.

FIG. 6 is an inverted view of the reinforcement frame of FIG. 5.

FIG. 7 is an abbreviated, exploded, isometric view of a conventional direct type backlight module.

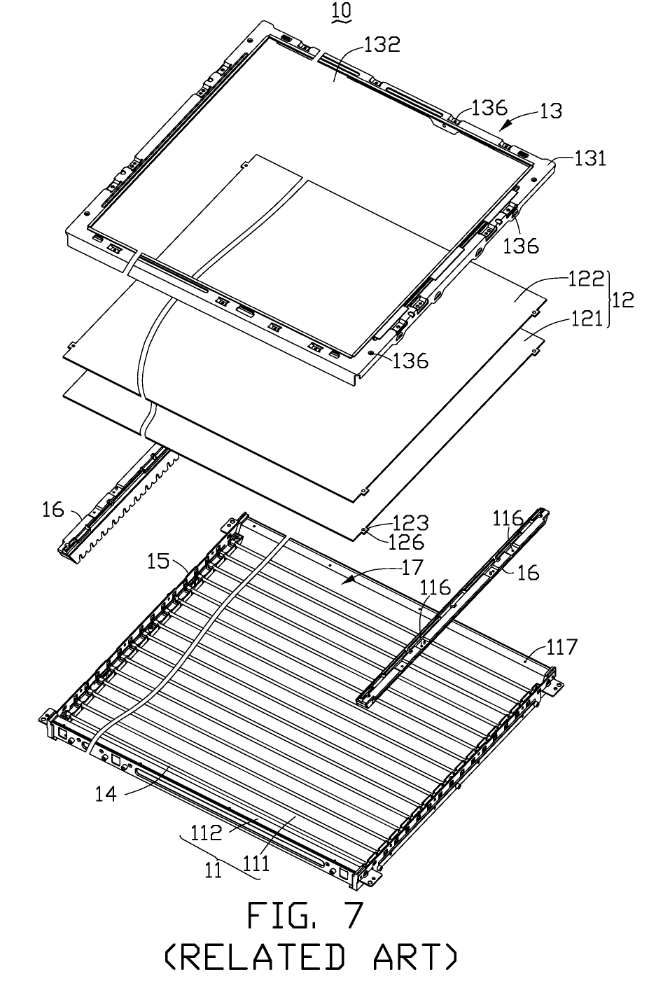

### DETAILED DESCRIPTION OF THE PREFERRED EMBODIMENTS

Reference will now be made to the drawings to describe preferred embodiments of the present backlight module, in detail.

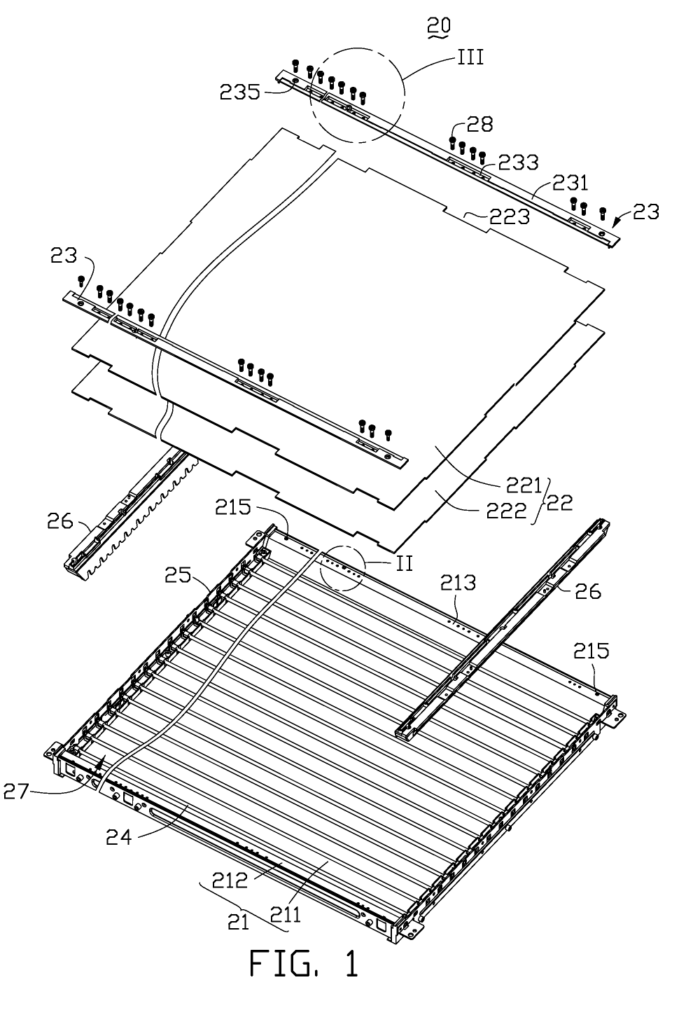

Referring to FIG. 1, a direct type backlight module 20 in accordance with a first preferred embodiment of the present invention is shown. The backlight module 20 includes a reflective plate 21, two optical plates 22, two reinforcement frames 23, a plurality of lamp tubes 24, two lamp-supporting units 25, two lamp-protecting units 26, and a plurality of screws 28. The lamp tubes 24 are typically cold cathode fluorescent lamps (CCFLs).

The reflective plate 21 includes a rectangular base 211, and two opposite sidewalls 212 extending from two opposite edges of the base 211. The two lamp-supporting units 25 are positioned on the base 211 adjacent two other opposite edges of the base 111, such that each of the lamp-supporting units 25 interconnects corresponding ends of sidewalls 212. The lamp-supporting units 25 are securely connected with the ends of the sidewalls 212 and the base 211 by a plurality of screws (not shown). Ends of each lamp tube 24 are respectively fixed to the two lamp-supporting units 25. The two lamp-protecting units 26 cover the two lamp-supporting units 25 respectively. The reflective plate 21, the lamp-supporting units 25, and the lamp-protecting units 26 collectively define a chamber 27 therebetween.

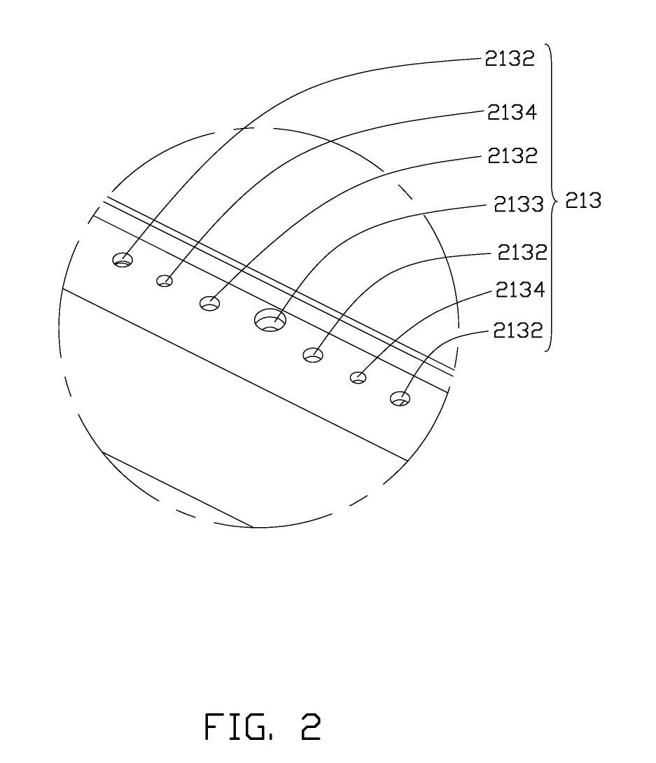

Referring also to FIG. 2, a top of each sidewall 212 defines five first locking portions 213 thereon (only parts of the five first locking portions 213 are shown in FIG. 1). The five first locking portions 213 are regularly spaced apart from each other, and include one central first locking portion 213, two end first locking portions 213, and two interposing first locking portions 213. The central first locking portion 213 includes four small screw holes 2132, a large screw hole 2133, and two positioning holes 2134, all of which except the large screw hole 2133 are aligned along a single line. The large screw hole 2133 is disposed at a center of the first locking portion 213, and is slightly offset from the single line. The four small screw holes 2132 and the two positioning holes 2134 are equally divided at two opposite sides of the large screw hole 2133 symmetrically. That is, two small screw holes 2132 and one positioning holes 2134 are located at each of the opposite sides of the large screw hole 2133. Distances between adjacent screw holes 2132, 2133, and 2134 are substantially the same. Each interposing first locking portion 213 includes four small screw holes 2132, and one positioning hole 2134. Two of the small screw holes 2132 are at one side of the positioning hole 2134, and the other two small screw holes 2132 are at an opposite side of the positioning hole 2134. Each end first locking portion 213 only includes two small screw holes 2132 and one positioning hole 2134. That is, each end first locking portion 213 is only about half of the central first locking portion 213, and does not include a large screw hole 2133. The positioning hole 2134 of each end first locking portion 213 is disposed between the two small screw holes 2132.

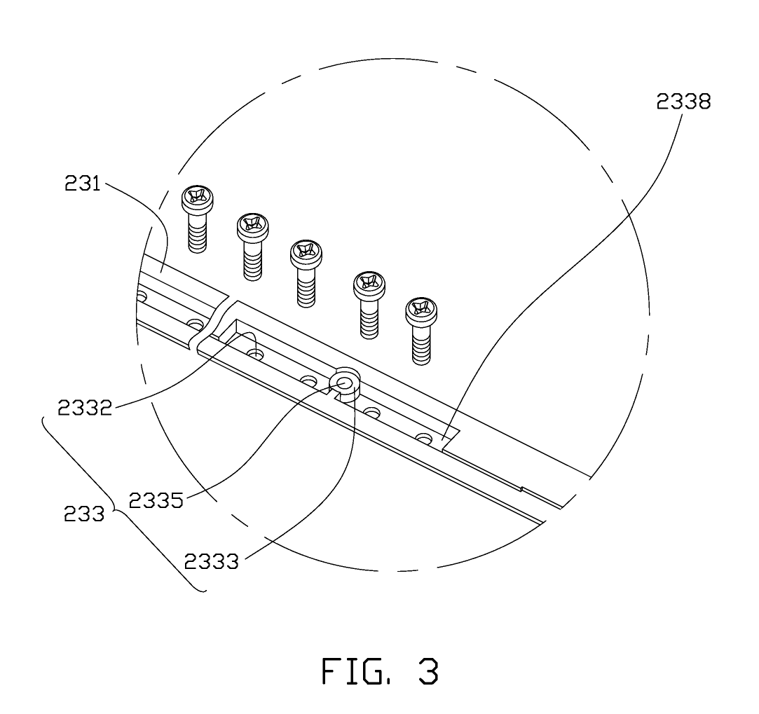

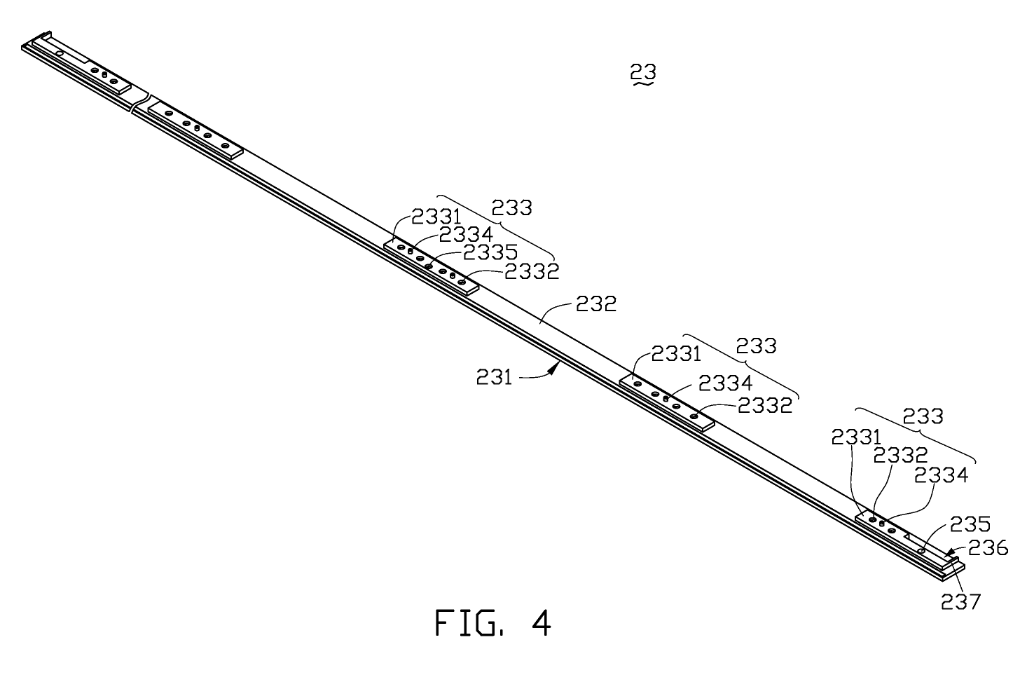

Referring to FIGS. 1, 3 and 4, each reinforcement frame 23 is substantially an elongated sheet having an upper surface 231 and a lower surface 232. The reinforcement frame 23 may be formed of metallic material, plastic, or a suitable combination thereof. A length of the reinforcement frame 23 is configured to be similar to that of a corresponding sidewall 212 of the reflective plate 21. The reinforcement frame 23 includes five second locking portions 233 regularly spaced apart from each other, and corresponding to the five first locking portions 213 of the respective sidewall 212. In particular, the five second locking portions 233 include one central second locking portion 233, two end second locking portions 233; and two interposing second locking portions 233.

The central second locking portion 233 includes a depression 2338, a bottom protruding block 2331, four small through holes 2332, a screw column 2333, and two columnar positioning posts 2334. The protruding block 2331 protrudes down from the lower surface 232. The depression 2338 is defined at the upper surface 231, corresponding to the protruding block 2331. The screw column 2333 is formed in the depression 2338, and defines a third screw hole 2335 therethrough corresponding to the large screw hole 2133 of the respective central first locking portion 213. The two columnar positioning posts 2334 extend down from the protruding block 233, and correspond to the two positioning holes 2134 of the central first locking portion 213. The four small through holes 2332 are defined in the protruding block 233, and correspond to the four small screw holes 2132 of the central first locking portion 213.

Each interposing second locking portion 233 includes a bottom protruding block 2331, four small through holes 2332, and a columnar positioning post 2334 extending down from the protruding block 2331. Two of the small through holes 2332 are at one side of the protruding block 2331, and the other two small through holes 2332 are at an opposite side of the protruding block 2331. Each end second locking portion 233 includes, a depression 2338, a corresponding protruding block 2331, two small through holes 2332, and a columnar positioning post 2334 extending down from the protruding block 2331.

Referring to FIG. 1, the optical plates 22 include a light diffusion plate 221 and a prism sheet 222. The light diffusion plate 221 and the prism sheet 222 can be supported by the sidewalls 212 of the reflective plate 21. Each of opposite sides of the light diffusion plate 221 and the prism sheet 222 defines five cutouts 223, the cutouts 223 corresponding to the first locking portions 213 of the opposite sidewalls 213. A height of each of the protruding blocks 2331 of the reinforcement frames 23 is preferably equal to a combined thickness of the optical plates 22, so that edge portions of the optical plates 22 between the cutouts 223 are received in spaces defined between adjacent protruding blocks 2331.

In this embodiment, each reinforcement frame 23 further includes two second blocks 237 adjoining the protruding blocks 2331 at the end second locking portions 233 respectively. Each second block 237 defines a second through hole 235 and a second cutout 236 therein. The second cutout 236 is configured for fittingly receiving a corresponding corner portion of each of the optical plates 22. The sidewalls 212 further include a plurality of second screw holes 215 corresponding to the second through holes 235, for fixing the corner portions of the optical plates 22 tightly on the top thereof with a plurality of screws 28.

A screw (not shown) may be directly screwed into the large screw hole 2133 of each central first locking portion 213, whereby other components (not shown) of the backlight module 20 can be attached to the sidewall 212. In an alternative embodiment, the large screw hole 2133 can be omitted from each central first locking portion 213. Similarly, the screw column 2333 of the second locking portion 233 of each reinforcement frame 23 is also used for attaching other components on the reinforcement frame 23; and in an alternative embodiment, the screw column 2333 and the third screw hole 2335 can be omitted from the reinforcement frame 23.

The process of assembling the optical plates 22 onto the sidewalls 212 of the reflective plate 21 is simple. Firstly, the optical plates 22 are stacked onto the sidewalls 212, such that the first locking portions 213 of the top of the sidewalls 212 are exposed through the corresponding cutouts 223 of the optical plates 22. Secondly, the columnar positioning posts 2334 of the reinforcement frames 23 are inserted into the positioning holes 2134 of the sidewalls 212 correspondingly, thereby the reinforcement frames 23 are positioned on the sidewalls 212. Thirdly, the reinforcement frames 23 are locked into the sidewalls 212 by a plurality of screws 28, which are inserted through the small through holes 2332 and engaged in the small screw holes 2132. Thereby, two sides of each of the optical plates 22 are clamped firmly against the sidewalls 212 by the lower surfaces 232 of the reinforcement frames 23. Alternatively, only some of the screws 28 and small screw holes 2132 may be utilized.

Compared with the above-described conventional backlight module 10, the backlight module 20 has a relatively lightweight design without the need for employing an upper frame.

It is noted that the numbers and shapes of the first locking portions 213 and the second locking portions 233 are not limited to the above description. At least one first locking portion 213 for each sidewall 212 and at least one second locking portion 233 for each reinforcement frame 23 can be employed, as long as the first locking portions 213 and the second locking portions 233 cooperatively fix the optical plates 22 on the sidewalls 212 of the reflective plate 21. Similarly, the numbers and shapes of the small through holes 2332 and the columnar positioning posts 2334 of the second locking portions 233, and the numbers and shapes of the small screw holes 2132 and the positioning holes 2134 of the first locking portions 213, are not limited to the above description.

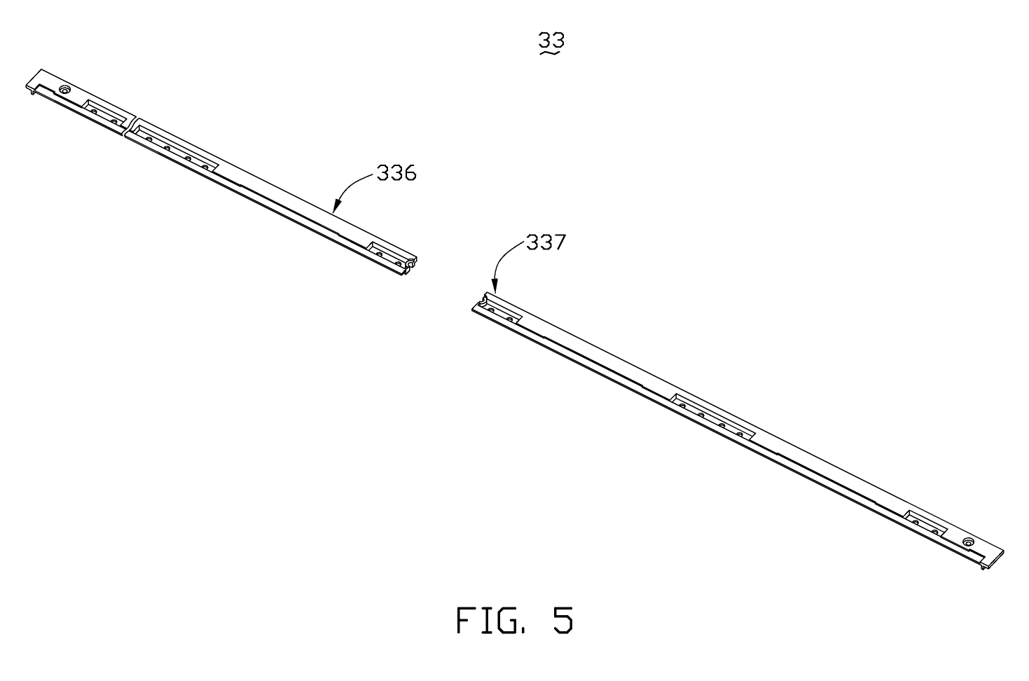

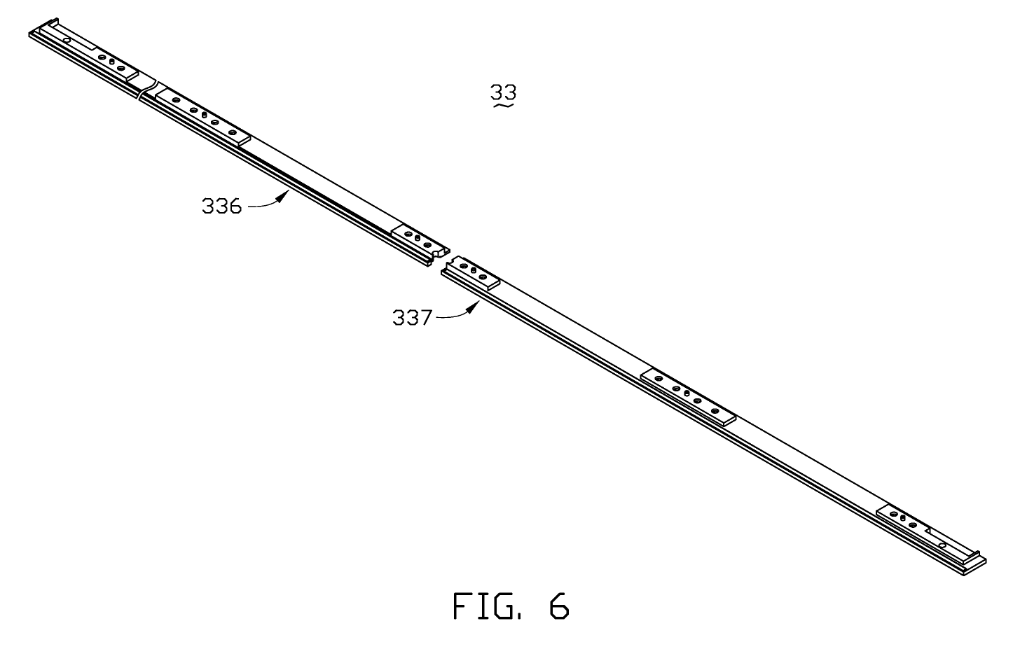

Referring to FIGS. 5 and 6, these show a reinforcement frame 33 of a direct type-backlight module in accordance with a second preferred embodiment of the present invention. The reinforcement frame 33 includes a first frame member 336 and a second frame member 337. The first frame member 336 is structured that same as a half of the reinforcement frame 23 of the first embodiment, and the second frame member 337 is structured that same as the other half of the reinforcement frame 23. Accordingly, when the first and second frame members 336 and 337 are used together, they form the equivalent of one reinforcement frame 23. Any combination of the first and/or second frame members 336 and 337 can be employed to replace the reinforcement frames 23 of the first embodiment. In alternative embodiments, there can be three or more frame members, which when used together form the equivalent of one reinforcement frame 23. Each such frame member includes one or more corresponding second locking portions 233. Any combination of two or more of such frame members can be employed to replace the reinforcement frames 23 of the first embodiment.

It is to be understood that the screw holes 2132, 2133 of the first locking portions 213 can be replaced by rivet holes. Correspondingly, the screws 28 used to fix the optical plates 22 can be replaced by rivets.

In other alternative embodiments, the reflective plate 21 may further include two sidewalls extending from two other opposite edges of the base 211. A plurality of light emitting diodes may be employed as a light source to replace the lamp tubes 24. The backlight module 20 may employ only a single optical plate 22, such as the light diffusion plate 221. Further, the backlight module 20 may employ any desired combination of optical plates 22 and/or other optical sheets. For example, the optical plates 22 and/or optical sheets may include at least one light diffusion plate, at least one prism sheet, and a light diffusion film, or any other suitable combination of optical plates 22 and/or optical sheets for improving optical performance.

Finally, while particular embodiments have been described above, the description is illustrative and is not to be construed as limiting the invention. Various modifications can be made to the embodiments by those skilled in the art without departing from the true spirit and scope of the invention as defined by the appended claims.

What is claimed is:

1. A direct type backlight module, comprising:
a reflective plate having a base and at least two opposite sidewalls extending from the base, wherein a top of each sidewall defines at least one first locking portion;
at least one optical plate disposed on the sidewalls;
a plurality of light sources positioned between the optical plate and the base of the reflective plate; and
two reinforcement frames each having at least one second locking portion, the second locking portions corresponding to the first locking portions, wherein the second locking portions and the first locking portions are assembled together by a plurality of fixing members such that the at least one optical plate is fixed on the sidewalls.

2. The direct type backlight module according to claim 1, wherein each first locking portion comprises at least one small screw hole and at least one positioning hole.

3. The direct type backlight module according to claim 2, wherein each reinforcement frame has an elongated body with an upper surface and a lower surface, at least one of the at least one second locking portion comprises a protruding block extending out from the lower surface, a depression defined at the upper surface corresponding to the protruding block, at least one through hole corresponding to the at least one small screw hole of a respective one of the at least one first locking portions, and at least one columnar positioning post defined on the protruding block corresponding to the at least one positioning hole of the respective at least one first locking portion, the columnar positioning posts of the reinforcement frames are received in the corresponding positioning holes, and the reinforcement frames are locked onto the sidewalls with the fixing members extending through the small through holes and being engaged in the small screw holes.

4. The direct type backlight module according to claim 3, wherein each reinforcement frame comprises at least three second locking portions, which include said at least one of the at least one second locking portion and two end second locking portions at opposite sides of said at least one of the at least one second locking portion, and each reinforcement frame further comprises two second block portions adjoining corresponding protruding blocks of the end second locking portions respectively, each second block portion defines a second through hole and a second cutout, the second cutout receives a respective one of corner portions of the at least one optical plate, each sidewall further includes two second screw holes corresponding to the second through holes, and the second through holes and the second screw holes are configured for fixing the corner portions of the at least one optical plate on the sidewalls top using a plurality of screws.

5. The direct type backlight module according to claim 3, wherein each of least two of first locking portions further comprises a large screw hole between the at least one small screw hole and the at least one positioning hole, the large screw hole is configured for attaching other components of the direct type backlight module to the respective sidewall, each of said at least one of the at least one second locking portion further comprises a screw column defined in the depression, the screw column defines a third screw hole, and the large screw hole and the screw column are configured for attaching other components of the direct type backlight module at the corresponding reinforcement frame.

6. The direct type backlight module according to claim 1, wherein each of the fixing members is selected from the group consisting of a screw and a rivet.

7. The direct type backlight module according to claim 1, wherein a material of each of the reinforcement frames is selected from the group consisting of plastic, metallic material, and any combination thereof.

8. The direct type backlight module according to claim 1, further comprising two lamp-supporting units positioned on opposite sides of the base adjacent respective ends of the sidewalls, wherein the lamp-supporting units are secured to the ends of the sidewalls and the base by a plurality of fasteners.

9. The direct type backlight module according to claim 6, further comprising two lamp-protecting units covering the two lamp-supporting units respectively.

10. The direct type backlight module according to claim 1, wherein the light sources are cold cathode fluorescent lamps or light emitting diodes.

11. The direct type backlight module according to claim 1, wherein the at least one optical plate comprises at least two cutouts receiving the first locking portions and the second locking portions.

12. The direct type backlight module according to claim 11, wherein the at least one optical plate is selected from the group consisting of a light diffusion plate, a light diffusion film, a prism sheet, and any combination thereof.
